(19) United States
(12) Patent Application Publication
(10) Pub. No.: US 2009/0218207 A1
(43) Pub. Date: Sep. 3, 2009

(54) Switch with recessed push-button and gaming machine with recessed push-button switches

(76) Inventor: Oliver C. Mou, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 12/074,273

(22) Filed: Mar. 3, 2008

(51) Int. Cl. H01H 9/02

(52) U.S. Cl. 200/334

(57) ABSTRACT

A recessed push-button actuatable switch is disclosed. In one embodiment, the recessed switch includes a body having a first end and a second end, a push-button supported by the body having a user-actuatable portion, a switch activated by actuation of the push-button, and a protector mounted to the body and extending around at least a portion of the push-button. The protector prevents the push-button from being accidentally or inadvertently pressed by allowing the button to be pressed only from a substantially perpendicular direction. At the same time, the button remains easily accessed. The recessed switch is also disclosed mounted to a housing such as a gaming machine and a method is disclosed to retrofit existing buttons to have the protection afforded by the protector of the recessed switch.

### FIELD OF THE INVENTION

The present invention relates to push-button switches, and more particularly to a push-button type actuatable switch having the push-button thereof recessed.

### BACKGROUND OF THE INVENTION

Push-button type switches are utilized in thousands of applications. One common application for push-button switches is as an input device for a gaming machine. For example, a gaming machine may include a plurality of push-buttons permitting a user to indicate a input, such as to “hold” a card, place a “bet” of a monetary amount, “deal” cards or the like. In addition, gaming machines commonly include a “service” button to indicate to a gaming establishment that a particular machine requires service or repair.

In the gaming machine environment, the push-buttons are generally mounted to a portion of the gaming machine housing, such as a metal panel, so that they may be easily accessible. One problem with this is that the sensitivity of the buttons and their convenient placement often leads to certain buttons being inadvertently or accidentally pressed. For example, in Blackjack, a user may accidentally press “deal” when he or she intends to “hold”. In addition, the user may accidentally press or activate the “service” button requiring a technician to be dispatched even though no service is required. Therefore, it is desirable to have button which is easily accessible to users while helping to prevent accidental activations or presses.

During the lifetime of the gaming machine, the buttons of the machine may be used tens of thousands of times. It is therefore important to provide a push-button switch which will accept a high duty cycle and has a long-life. Among other things, components of a button may need to be replaced in order to maintain the button, or else the entire button must be replaced. It is therefore also important to provide a button which is reliable and with low maintenance requirements while being able to prevent accidental activation or presses. Thus, it is also desirable that the aspect of the button which prevents accidental or inadvertent activation is at least as durable, reliable, and low maintenance as the button itself.

There are thousands and thousands of push-buttons already associated with existing gaming machines. It is desirable to find a solution to the above-stated problems which does not require modification of the gaming machine and which does not require complete replacement of the push-button, due to the prohibitive cost of those solutions.

### SUMMARY OF THE INVENTION

Disclosed herein is a push-button actuatable switch with a recessed push-button, a gaming machine with one or more recessed push-button actuatable switches, and a method of retrofitting a switch of a gaming machine to reduce accidental user actuation. The push-button actuatable switch is actuatable in that a user may actuate the switch or a portion thereof.

In one embodiment, the push-button actuatable switch includes a button body having a first end and a second end, a push-button supported by the body and extending from the first end of the body, a switch actuatable by the push-button, and a protector mounted to the body and extending upwardly around at least a portion of the push-button.

The push-button may have a user-actuatable portion and may be movable from a first non-actuated position to a second actuated position in which the push-button actuates the switch. In some embodiments, the push-button maybe biased outwardly to the first non-actuated position while being depressed inwardly towards the button body when in the second actuated position. In addition, portions of the push-button actuatable switch may be configured in various shapes. For example, the user-actuatable portion of the push-button, the protector, or both may be generally square in peripheral shape.

The protector may have an open top end extending even with or beyond the user-actuatable portion of the push-button when the push-button is in a non-actuated position. Further, the protector may also comprise a bottom end, comprising a lip to accept the body of the push-button, opposite the top end. The protector is preferably a separate element of the push-button actuatable switch. In some embodiments, the protector may extend around the entire perimeter of the push-button while in others the protector may only extend around a portion of the perimeter of the push-button.

In one embodiment, the gaming machine having a push-button actuatable switch in accordance with the invention herein includes a housing defining a generally closed interior area and an exterior area, a push-button actuatable switch mounted to the housing. The push-button actuatable switch may be configured in various ways (including the configurations disclosed herein). In one embodiment, the push-button actuatable switch comprises a button body having a first end and a second end, the body extending through the housing of the gaming machine from the interior to the exterior area thereof, a push-button supported by the body and having a user-actuatable portion extending from the first end of the body so as to be accessible at the exterior of the gaming machine, a switch actuatable by the push-button, and a protector mounted to the button body and extending upwardly around at least a portion of the push-button.

As with above, the push-button may be movable from a first non-actuated position to a second actuated position in which the push-button actuates the switch. Further, the gaming machine of one or more embodiments may have a plurality of push-button actuatable switches (as disclosed in various configurations herein) mounted to its housing.

In addition, the protector may have an open top end extending even with or beyond the user-actuatable portion of the push-button when the push-button is in its non-actuated position. Also, the protector may extend upwardly around the entire perimeter of the push-button if it is so desired. The protector, in one embodiment, may be mounted between a flange defined by the body and the housing of the gaming machine. In one embodiment, the protector may have a peripheral shape corresponding to the peripheral shape of the push-button.

In one embodiment, a method of retrofitting an existing push-button actuatable switch of a gaming machine to reduce accidental user actuation thereof comprises disconnecting a push-button actuatable switch from the housing of the gaming machine, mounting a protector to the button body whereby the protector extends upwardly around at least a portion of the push-button, and reconnecting the push-button actuatable switch to the gaming machine. The push-button actutable switch and protector may be configured in various ways including the configurations described above. Notably, the step of mounting a protector to the body may be performed prior to the first mounting of the push-button actuatable switch to the gaming machine.

Further objects, features, and advantages of the present invention over the prior art will become apparent from the detailed description of the drawings which follows, when considered with the attached figures.

### DESCRIPTION OF THE DRAWINGS

FIG. 1 is a perspective view a recessed push-button actuatable switch of the invention with a protector extending around its perimeter;

FIG. 2 is a side view of a recessed push-button actuatable switch of the invention mounted to a support structure in the form of a gaming machine housing;

FIG. 3 is an exploded view of the recessed push-button actuatable switch illustrated in FIG. 2;

FIG. 4A is a cross-sectional view of the recessed push-button actuatable switch illustrated in FIG. 2;

FIG. 4B is a perspective view of a body of the recessed push-button actuatable switch illustrated in FIG. 4A looking in a direction from a bottom end towards a top end thereof;

FIG. 5 is a perspective view of a lamp/switch mount of the recessed push-button actuatable switch of the invention;

FIG. 6 is a top view of the recessed push-button actuatable switch protector of the invention; and

FIG. 7 is a perspective view of four push-button actuatable switches mounted to a support structure.

### DETAILED DESCRIPTION OF THE INVENTION

The invention is a recessed push-button actuatable switch and a method for providing the same. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is a protector for a push-button type actuatable switch, whereby the push-button of the switch is protected from being accidentally pressed or activated. In one or more embodiments, the protector extends upwardly even with or beyond the user-actuatable portion of the push-button. This configuration ensures that unintended contact with the switch does not engage or activate the switch. The protector may be associated with or integrated into new push-button type switches, or be retrofit to existing buttons or switches. The push-button actuatable switch is actuatable in that a user may actuate the switch or a portion thereof.

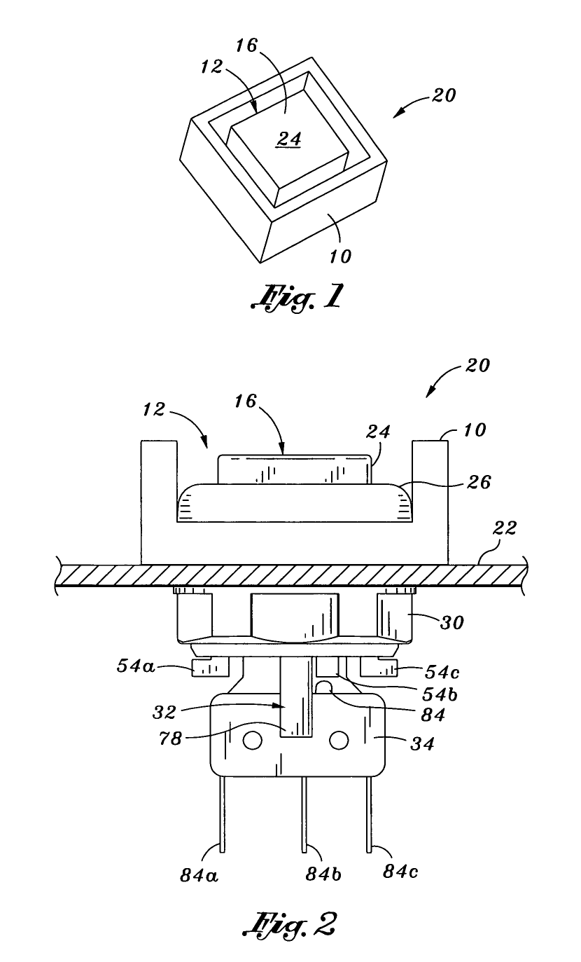

One embodiment of the invention is a protector which may be utilized with a push-button actuatable switch in order to recess the push-button thereof against accidental actuation. Referring to FIG. 1, a push-button type actuatable switch 20 has a push-button 24 or other user-actuatable member. The push-button 24 has a user-actuatable portion 16 which, as illustrated, comprises a generally planar top thereof. As detailed below, a user may contact the user-actuatable portion 16 of the push-button 24, depressing the push-button 24 so as to activate the switch 20. In one embodiment, as detailed below, actuation of the push-button 24 actuates an electrical switch.

As illustrated, a protector 10 is associated with the push-button actuatable switch 20. In one embodiment, the protector 10 comprises a body having an upwardly extending wall or other member. The wall of the protector 10 is configured to extend upwardly around a perimeter of the push-button 24. The protector 10 is open at a top thereof, thus defining an open interior space within which the push-button 24 is located. As detailed below, the push-button 24 may be moved from a first undepressed position to a second depressed position. In a preferred embodiment, a top portion of the protector 10 extends outwardly approximately as far as the user engageable portion 16 of the push-button 24. In this manner, the push-button 24 is protected from being accidentally engaged because the push-button 24 is recessed within the protector 10 so as to be engageable only in a direction substantially perpendicular to the top of the push-button. At the same time, the open top 12 of the protector 10 allows the push-button 24 to be easily and conveniently engaged when a user or other person seeks to do so.

The recessed switch 20 illustrated in FIG. 1 comprises a protector 10 that extends beyond the top of the user-actuatable portion 16 of the push-button 24. It is contemplated however, that in one or more embodiments the protector 10 may extend such that it is even with or flush with the top of the user-actuatable portion 16 of the push-button 24. FIG. 1 also illustrates a protector 10 around the perimeter of the push-button 24. It is contemplated however, that in one or more embodiments the protector 10 may extend around a portion of the push-button 24 rather than around its entire perimeter.

The protector 10 may extend various amounts beyond the top of the user-actuatable portion 16 of the push-button 24. The push-button 24 of various embodiments extends a predetermined distance from the body 26 (described below) in its undepressed condition. Thus, in one embodiment, the protector 10 may extend beyond the top of the user-actuatable portion 16 from 5% to 25% of this predetermined distance. In another embodiment, the protector 10 may extend a fixed amount beyond the top of the user-actuatable portion 16 such as from 1/16th of an inch to ½ of an inch. In other embodiments, the amount the protector 10 extends may be determined based on the size of the push-button 24, the user-actuatable portion 16, or both. In addition, the amount the protector 10 extends may also be determined by taking into account the portion of horizontal space of the open top 12 or gap between the protector 10 and the push-button 24. For example, the protector 10 may extend a greater amount where this gap is large because the push-button 24 is more easily accessed and thus accidental engagement of the push-button is more likely. Alternatively, the protector 10 may extend a lesser amount where this gap is small because the push-button is less easily accessed and accidental engagement of the push-button is less likely. It is contemplated that the amount the protector 10 extends may be determined by the amount of protection required for a particular button. However, the amount of extension may vary for other reasons such as but not limited to addressing aesthetic, reliability, maintenance, or other concerns.

As stated, there is a portion of horizontal space or a gap between the protector 10 and the push-button 24. This gap may vary in size in one or more embodiments to provide greater or lesser protection for the push-button, or to address aesthetic, reliability, maintenance or other concerns. The size of the gap and consequently the configuration of the protector's 10 open top may be determined by a percentage, fixed amount, or other factor similar to the way the amount of extension is determined as described above. In one embodiment, the gap may be between 25% and 50% of the horizontal length of the push-button 24 or the user-actuatable portion 16. In another embodiment, the gap may be between 1/16th and ½ of an inch. In addition, the size of the gap may vary along the perimeter of the push-button 24 such as for example where the push-button is circular and the protector 10 is rectangular or vice versa.

In a preferred embodiment, the protector 10 is located adjacent the perimeter of the push-button 24, so as to not create a large opening or depression between it and the push-button. In this regard, as detailed below, the purpose of the protector 10 is to define a body or member which shields the push-button.

The protector 10 may be made from a variety of materials and may be of one or more colors. The choice of materials and colors may be for aesthetic purposes such as to match a gaming machine or may be for other reasons such as enhanced reliability for a particular environment, in the case of material choice, or to indicate a particular button function, in the case of color. Some exemplary materials from which the protector 10 may be made include plastic, metal, wood, carbon fiber, fiberglass, and other man made and natural materials. Additionally, the materials themselves may have one or more colors or may be coated with one or more colors. Finally, the protector 10 may be made of transparent or semi-transparent materials that may be clear or colored.

As illustrated in FIG. 2, the push-button actuatable switch 20 maybe mounted to a support structure. As illustrated, the recessed switch 20 is mounted to a panel or housing 22 of a gaming machine. In general, the push-button 24 extending from a top portion or end of a body or housing 26 of the switch 20. The protector 10 and lock nut 30 are associated with an exterior portion of the body 26. A lamp/switch mount 32 is connected to the body 26 and extends from a bottom portion or end thereof generally opposite the push-button 24. An electrical switch 34 is connected to the lamp/switch mount 32.

In the arrangement illustrated, the housing 22 comprises a metal panel forming a portion of a body or housing of the gaming machine. The housing 22 has an aperture there through. Preferably, the body 26 extends through the aperture. The aperture is larger than the portion of the body 26 which extends there through, but smaller in dimension that the protector 10. The protector 10 is positioned over the body 26 adjacent a top side of the housing 22, obscuring the aperture through which the body extends. The lock nut 30 is affixed to the body 26 from the bottom side of the housing 22. In this manner, the housing 22 is positioned between the protector 10 and the lock nut 30, securing the recessed switch 20 to the housing 22.

As detailed below, the push-button 24 extends outwardly from the body 26 for engagement by a user thereof, such as by a player of the gaming machine. When depressed or pushed by a user, the push-button 24 is arranged to activate/actuate the electrical switch 34. Leads extend from the electrical switch 34, and wires may be connected to the leads and extend to another device, whereby the signal from the electrical switch 34 is used as an input to that device.

FIG. 2 shows an embodiment of the protector which extends around a portion of a push-button 24. In this embodiment, the protector 10 extends around two sides of the push-button 24 rather than around the push-button's entire perimeter. It is contemplated that in one or more embodiments, the protector 10 may extend around only a portion of the push-button 24, such as one or more sides thereof.

Also, in one or more embodiments, the top of the protector 10 need not be flat or level, but may extend to varying heights such as to form a slope or curve along part or all of the perimeter of the push-button. In addition, the protector 10 in one or more embodiments may be rotated to any angle best suited to protect the push-button from accidentally being engaged. For example, the protector 10 illustrated in FIG. 2 may be positioned such that the portion of the protector that extends around the push-button 24 faces the user.

FIG. 2 also shows an embodiment where the protector 10 extends beyond the user-actuatable portion 16 of the push-button 24. As stated, this configuration protects the push-button 24 from being accidentally engaged. However, the same may be accomplished in one or more embodiments by a protector 10 which extends flush or even with the top or user-actuatable portion 16 of the push-button 24. In addition, it is contemplated that the protector 10 may be configured to extend beyond the user engageble portion 16 of the push-button 24. The greater the distances the protector 10 extends beyond the user engagable portion 16, the lower the likelihood that the push-button 24 will be accidentally engaged. However, as the protector 10 extends outwardly beyond the push-button 24 by larger distances, the profile of the switch 20 increases. This may obscure adjacent elements or make the push-button 24 difficult to engage, even if intentionally. Therefore, in one or more embodiments the amount the protector 10 extends maybe varied to provide the best protection for a particular situation.

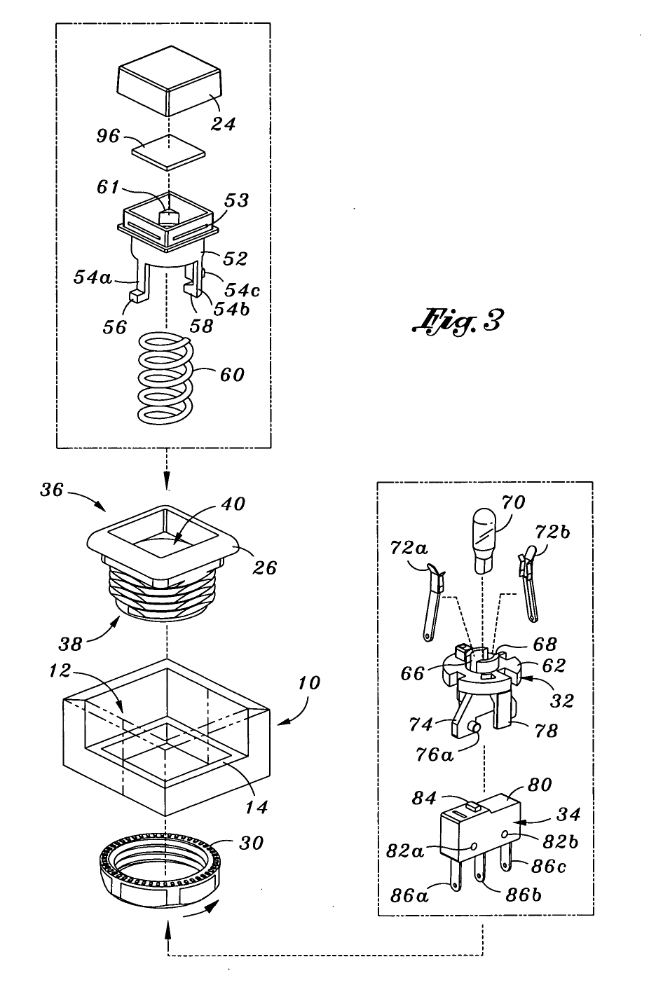

The protector of the invention may be used with or incorporated into push-button type switches having a various embodiments. One embodiment of such a switch will be described in detail with reference to FIG. 3. As illustrated, the body 26 serves a supporting/housing function and includes a wall having inner and outer surfaces. In one embodiment, the body 26 is generally tubular and has a top or proximal end 36 and a bottom or distal end 38. A passage 40 extends through the body 26. As illustrated, at its top end 36, the body 26 is generally square, thus defining a generally square periphery of the passage 40. The body 26 may have a variety of other shapes at this location, such as round or rectangular. Preferably, the bottom end 38 of the body 26 is generally cylindrical, thus defining a generally circular periphery of the passage 40 at that location. In one or more embodiments, an outer surface of the body 26 is threaded at its bottom end 38. The threads extend upwardly towards the top end 36. The threads are adapted to accept mating threads on the lock nut 30.

FIG. 3 also illustrates an embodiment of the protector 10 with an open top 12 having a lip 14 to accept a body 26. In this embodiment, the lip 14 is configured to receive the top end 36 of the body 26. The threads at the bottom end 38 of the body 26 may then extend through the protector 10 so that the mating threads on the lock nut 30 may secure the protector and body to a supporting surface. As stated, the top end 36 of the body 26 may have a variety of shapes and thus the protector 10 may be configured to extend around a portion or the entire perimeter according to the shape of the body. In addition, the protector 10 in one or more embodiments may have a different shape than the perimeter of the body 26, the push-button 24, or both.

It is contemplated that one or more spacers shaped similarly to the lip 14 may be used to adjust the distance the push-button 24 is recessed or to make the user-actuatable portion 16 of the push-button even with the top of the protector 10. The spacers may have varying heights and may be placed between the lip 14 and the body 26 where desired.

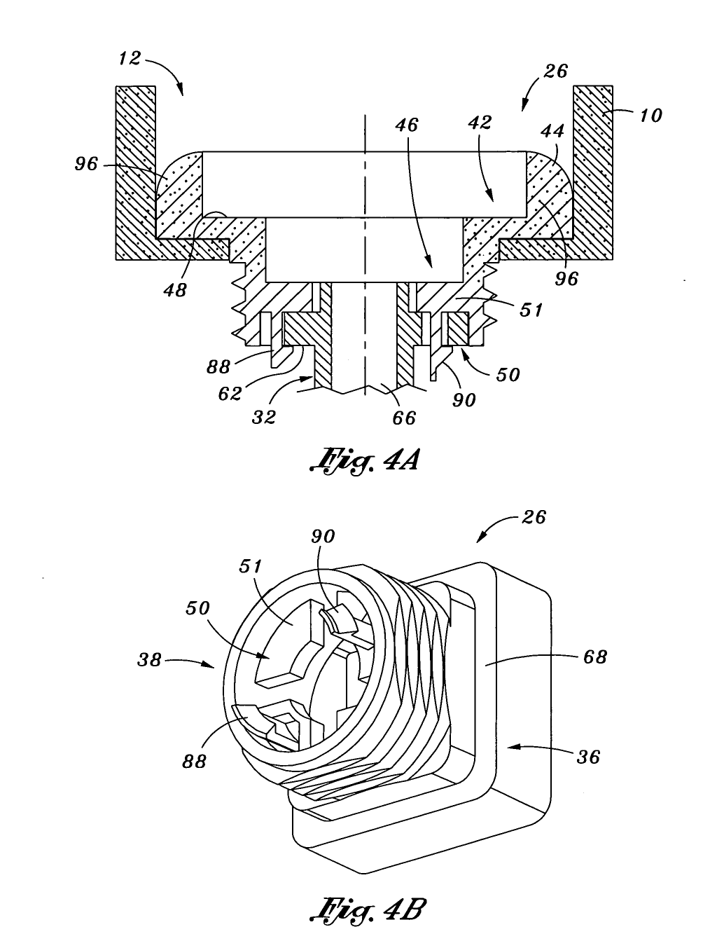

The configuration of the invention is illustrated in more detail in FIGS. 4A and 4B. As illustrated, the protector 10 is associated with a body 26 of the push-button 24. In various embodiments, the protector 10 may extend around a portion rather than the entire perimeter of the push-button 24. The protector 10 may also be formed to have a different shape than the perimeter of the body 26 if so desired. The protector 10 maybe so associated with the push-button 24 various manners, however. For example, the protector 10 may have a threaded portion which engages a corresponding threaded portion on the remainder of the push-button switch 20 such as the body 26. In this embodiment, the protector 10 may be attached to the push-button switch 20 by matching the corresponding threaded portions and threading the threaded portion of the protector 10 onto the corresponding threaded portion of the body 26, or vice versa. The protector 10 may be permanently affixed using mechanical fasteners alone or in combination with various adhesives. Of course, the protector 10 does not have to be permanently affixed in all embodiments.

The protector 10 may also comprise a plurality of separate elements. In one embodiment, the protector 10 may be made of two portions which may be connected when the protector is attached or installed. For example, the protector shown in FIG. 3 may be configured in two mating halves divided along the two vertical dashed lines illustrated. Each half may then be placed around a portion of the body 26 such as by horizontally engaging one side of the body with one half of the protector 10 and then engaging the other side of the body with the other half of the protector such that the two halves form a complete protector such as shown in FIG. 3. One half of the protector may have one or more fasteners which correspond to one or more corresponding fasteners on the other half of the protector. In this way the protector may be assembled by connecting the fasteners of one half to the corresponding fasteners of the other half. In addition, adhesive may be used alone or in combination with these or other fasteners to connect the two halves of a protector.

Of course, the protector 10 may be divided into more than two portions and such divisions may be other than straight vertical divisions. Each portion of the protector 10 may include one or more mechanical fasteners integrated with that portion such that the protector may be assembled by engaging corresponding fasteners of the various portions. Adhesive may also be used to further secure an assembled protector 10 in one or more embodiments, or adhesive may be the only fastener used to assemble a protector 10. It is also contemplated that additional fasteners such as but not limited to screws or pins may be used alone or in combination in assembly of a protector 10.

Referring to FIG. 4A, in one or more embodiments, the body 26 may define an upper cavity 42 for accepting at least a portion of the push-button 24. The upper cavity 42 forms a portion of the passage 40 through the body 26. As illustrated, when the push-button 24 is generally square in peripheral shape, so is the upper cavity 42. As described above, the body 26 defines a periphery around the upper cavity 42 which is also generally square. As illustrated, the body 26 includes an outwardly extending flange 44 in this location. As noted above, the push-button 24 may be other than square, in which case the body 26 at this location is as well, for example round or rectangular.

A middle cavity 46 is positioned below the upper cavity 42 and also forms a portion of the passage 40. The middle cavity 46 is preferably cylindrical in shape, and has a diameter which is less than the maximum dimension of the upper cavity 42. As a result of the change in size and shape between the upper and middle cavities 42,46, a ledge 48 is defined. As detailed below, the ledge 48 serves as a stop to limit the travel of the push-button 24 downwardly into the body 26, and serves as a support for a spring.

A lower cavity 50 is positioned below the middle cavity 46 and also forms a portion of the passage 40. The lower cavity 50 is also preferably generally cylindrical in shape. As illustrated, a stop extends inwardly dividing at least a portion of the middle and lower cavities 46,50. Referring to FIG. 4B, the stop comprises four wall or stop segments 51.

As described above, a push-button 24 is associated with the body 26, and preferably is located at the top end 36 thereof. At least a portion of the push-button 24 is adapted to extend from the top end 36 of the body 26 to form a user-actuatable portion 16. Referring to FIG. 3, the push-button 24 comprises a generally square member having a user-actuatable portion 16 at its top and one or more sides or members extending downwardly therefrom. The push-button 24 may have a variety of other shapes, including rectangular and circular.

The push-button 24 may have an actuator 52. In these embodiments, the actuator 52 has a first end shaped to accept the push-button 24 there over. When the push-button 24 is square, preferably so is the first end of the actuator 52. Likewise, when the push-button 24 has other shapes such as rectangular or circular, the first end of the actuator 52 may be as well. Notably, the first end of the actuator 52 and the push-button 24 need not be the same shape, as long as the connecting function between the two is facilitated. As illustrated, one or more tabs 53 may be located on the outside of the first end of the actuator 52 for use in securing the push-button 24 to the actuator 52.

The actuator 52 has a generally cylindrical main portion adapted to fit within the middle cavity 46 of the body 26. Preferably, three legs 54a,b,c, extend downwardly from the periphery of the main portion of the actuator 52 in a direction opposite its first end. A pair of the legs 54a,54c are preferably located about 180 degrees apart. The third leg 54b is positioned there between. As illustrated, the third leg 54b is preferably located nearer one of the legs 54c than the other of the legs 54a.

The opposing legs 54a,54c each have a catch 56 extending outwardly therefrom. Preferably, each catch 56 extends in a direction generally radially out in a direction perpendicular to an axis extending through the actuator. Referring to FIG. 2, when the actuator 52 is positioned in the body 26, the legs 54a,b,c, extend through spaces between the stop segments 51 of the body 26. When so positioned, the catches 56 engage a lower rim of the body 26, preventing further upward movement of the actuator 52.

A foot 58 is located on the end of the second leg 54b. As described in more detail below, the foot 58 is adapted to engage a button of the electrical switch 34 for actuating the switch. As illustrated, the foot 58 extends radially inward from the leg 54b.

A spring 60 is positioned inside of the body 26 and engages both the body 26 and the actuator 52. In a preferred embodiment, the spring 60 is a helical spring. A first end of the spring 60 rests against the top surface of the stop segments 51 of the body 26. The second end of the spring 60 is positioned within the actuator 52 and rests against a stop 62 therein. So arranged, the spring 60 has the natural tendency to urge the actuator 52 upwardly to the point where further upward travel is limited by the catches 56. The urging of the actuator 52 upwardly also urges the push-button 24 attached thereto upwardly. When pressed by a user, the push-button 24 moves the actuator 52 downwardly against the biasing force of the spring 60, compressing the spring.

The lamp/switch mount 32 is connected to the body 26 at its bottom end 38. The lamp/switch mount 32 will now be described in detail with reference to FIG. 5. The lamp/switch mount 32 has a generally disc-shaped main portion 62. The main portion 62 has three cut-out areas 64a,b,c permitting passage of the legs 54a,b,c of the actuator 52 there through.

A passage 66 extends generally centrally through (i.e. along a central axis extending generally perpendicular to a plane in which the main portion 62 extends) the main portion 62. A lamp stand 68 extends upwardly from a top surface of the main portion 62 and downwardly from a lower surface of the main portion, defining a generally lower closed end. In general, the lamp stand 68 forms extended portions of the passage 66 for accepting therein a lamp 70 (see FIG. 3). First and second contacts 72a,b are also located in the passage 66. The first and second contacts 72a,b contact leads or contacts on the lamp 70. The contacts 72a,b extend through the lower closed end of the lamp stand 68 for connection to appropriate power wires for powering the lamp.

A switch mount 74 extends below the main portion 62 of the lamp/switch mount 32. The switch mount 74 is offset from the central axis. In one embodiment, the switch mount 74 extends from the lamp stand 68. The switch mount 74 includes first and second spaced pins 76a,b. A lock 78 extends downwardly from the main portion 62. The lock 78 is spaced apart from the pins 76a,b, defining a space in which the electrical switch 34 may be located.

Referring to FIG. 3, the electrical switch 34 has a generally closed housing 80. The electrical switch 34 may have a variety of shapes and configurations. As illustrated, the housing 80 is generally rectangular. First and second passages 82a,82b extend through the housing 80 from side to side. The passages 82a,b are adapted to accept the first and second pins 76a,76b of the lamp/switch mount 32.

A button 84 extends upwardly from a top surface of the housing 80. The button 84 preferably actuates an electrical switch within the electrical switch 34. In one embodiment, the electrical switch 34 is a two-position switch. The workings of such electrical switches 34 are well known. As is common in such a two-position electrical switch 34, the electrical switch 34 includes three leads or contacts 86a,b,c. The position of the electrical switch 34 determines which of the leads are “hot” (one being for ground).

When the electrical switch 34 is mounted to the lamp/switch mount 32, the pins 76a,b extend into the passages 82a,b. The lock 78 presses against the opposite side of the housing 80 of the electrical switch 34, maintaining the pins 76a,b in engagement with the passages 82a,b, securely mounting the electrical switch 34.

When so mounted, the foot 58 of the second leg 54b of the actuator 52 is positioned adjacent the button 84 of the electrical switch 32. When a user depresses the push-button 24, the actuator 52 is moved downwardly, causing the foot 58 to engage the switch button 84. This actuates the electrical switch 34.

Most importantly, in accordance with the invention there is provided an advantageous mounting arrangement for removably connecting the lamp/switch mount 32 to the body 26. Referring to FIGS. 4(a) and 4(b), first and second latches 88,90 extend from the bottom end 38 of the body 26. The latches 88,90 extend from the stop segments 51 of the body 26. Each latch 88,90 generally comprises a member extending outwardly from the stop segment, and includes a catch. As illustrated, the latches 88,90 are positioned generally 180 degrees apart, with the catches facing generally in the same direction.

The lamp/switch mount 32 includes a passage 92 through the main portion 62. The passage 92 accepts the latch 90 there through. A cut-out or recess 94 is provided in the periphery of the main portion 62 of the lamp/switch mount 32.

Referring to FIG. 4A, the lamp/switch mount 32 is arranged to be mounted in abutting relationship to the stop segments 51 at the bottom end 38 of the body 26. The top surface of the main portion 62 of the lamp/switch mount 32 is abutted against the lower surface of the stop segments 51 of the body 26. In this position, the latch 90 extends through the passage 92 in the lamp/switch mount 32, with the catch of the latch 90 engaging the lower portion of the main portion 62 of the lamp/switch mount 32. At the same time, the latch 88 extends along the cut-out area 94 in the main portion 62 of the lamp/switch mount 32, with the catch thereof also engaging the lower portion of the main portion 62 of the lamp/switch mount 32.

Preferably, as illustrated in FIG. 4A, the latches 88,90 are arranged to press the lamp/switch mount 32 both upwardly against the stop segments 51, and radially outwardly against the inside wall of the body 26 at its bottom end 38. Importantly, the latches 88,90 are slightly flexible, permitting a user to bend them out of engagement with the lamp/switch mount 32, thereby permitting the lamp/switch mount 32 to be removed from engagement with the body 26.

In one or more other embodiments, other means maybe provided for removably securing the lamp/switch mount 32 to the body 26. Preferably, the securing means includes at least one member which is accessible by a user for manipulation in unlocking or removing the lamp/switch mount 32 from the body 26. There may be only a single latch or more than one latch. The latch(es) may engage the lamp/switch mount 32 in a variety of manners. For example, the lamp/switch mount 32 need not include passages or cutout areas. The lamp/switch mount 32 may include a trough in the lower surface or in a side surface for engagement by a portion (such as a catch) of the latch(es). In one embodiment, a threaded rod may extend from the body 26 and through a passage/slot in the lamp/switch mount 32. A nut may be threaded onto the rod to engage the lamp/switch mount 32 with the body 26.

In one embodiment, the latches 88,90 may extend form the wall forming the body 26 instead of or in addition to the stop segments 51. In another embodiment, rotating lock members may be associated with the body 26 and moved into a locking position when the lamp/switch mount 32 is pressed into engagement therewith, and rotated out of the locking position to permit removal/disconnection of the lamp/switch mount 32 from the body 26. In general, it is desired that a release for the locking mechanism be accessible to the user.

The various components of the recessed switch 20 may be constructed from a wide range of materials. In one embodiment, the push-button 24, actuator 52, body 26, protector 10, lock nut 30, and lamp/switch mount 32 comprise plastic or a similar material conveniently constructed in a molding or extrusion process. The contacts 72a,72b and spring 60 preferably comprise metal members. In one or more embodiments, the various components may have a variety of colors.

In one embodiment of the invention, at least a portion of the body 26 around the push-button 24 is arranged to illuminate or be illuminated. In this manner, the location of the push-button 24 may be easily identified by a user. In a preferred embodiment, the body 26, the protector 10, or both are constructed from a transparent or generally transparent material, such as clear plastic, instead of traditional black polypropylene. Light emitted by the lamp 70 passes through the body 26, thereby illuminating the body 26, including the peripheral portion thereof at the top end 36 around the push-button 24.

In one embodiment, to provide significant contrast between the push-button 24 and the body 26, the push-button 24 is arranged to generally not transmit light emitted by the lamp 70. In one embodiment, the push-button 24 may be constructed of an opaque material. In another embodiment, a shield, such as plastic plate, may be located within the push-button 24. In this embodiment, the push-button 24 is generally not illuminated, but the surrounding body 26 is, whereby the illuminated body 26 generally serves to identify the extent/location of the push-button 24. In addition, the protector 10 may be illuminated with the body 26 if so desired. In a preferred embodiment, as illustrated in FIG. 3, a legend plate 96 is located inside of the push-button 24. The legend plate 96 may have lettering printed thereon which is readable through the push-button 24. For example, the legend plate 96 maybe printed with “deal/draw,” “bet one” or other words, numbers or symbols. In one embodiment, the legend plate 96 permits light illuminated by the lamp 70 to pass there through to render the lettering or other printing more visible. For example, the legend plate 96 may be a plastic plate of any of a variety of colors (even clear) having printing, such as black or other colored lettering.

In accordance with another aspect of the invention, the recessed switch 20 may be arranged to divert or ground electro-static discharge (ESD). In one or more embodiments of the invention, one or more of the components of the recessed switch 20 are adapted to conduct electrical energy to the housing 22 of the gaming machine or other support structure or remote location, and away from the circuitry of the lamp 70 and electrical switch 34.

In one embodiment, a path of electrical conduction is defined from an external portion of the recessed switch 20 to the housing 22 or other grounding element. In one or more embodiments, this pathway is defined by an electrically conductive material located in the recessed switch 20. In one embodiment, the body 26, protector 10, and/or lock nut 30 are constructed from plastic having a conductive carbon material interspersed therein. The interspersed conductive carbon (see FIG. 4A) defines a pathway through the component to the housing 22 or other ground. Preferably, sufficient conductive carbon is provided that the path of least resistence to the electrical energy is defined through the component to ground rather than through the component to the electrical switch 34 or lamp 70, and thereon to the associated circuitry.

It will be appreciated that in order to provide an effective pathway to ground, the housing 22 or other supporting structure may need to be specially configured. In one embodiment, the housing 22 may comprise a metal panel which is painted (such as powder coated). In such an embodiment, it is preferred that an area of contact be provided between the body 26, protector 10, lock nut 30 or other component of the recessed switch 20 directly with the metal of the housing 22.

In one embodiment, a metal strip or the like maybe connected to the recessed switch 20, such as sandwiched between the protector 10 and housing 22 or lock nut 30 and housing 22, with the metal strip extending to ground.

In another embodiment, the pathway through the recessed switch 20 to ground may comprise other than dispersed particles. In one embodiment, a wire may be embedded in the body 26 and extend from a top outer surface thereof to an contact with ground, such as the interface with the housing 22. Other interspersed materials may be used. An advantage of the interspersed material is that the location or proximity of the user's touch or approach to the recessed switch 20 need not then coincide with a specific location of the path to ground (as in the case of an embedded wire), since multiple paths to ground are provided.

In other embodiments, a layer of conductive material may be located on the one or more components of the recessed switch 20. For example, a thin layer of conductive metal may be deposited on the exterior of the body 26.

Assembly and use of the recessed switch 20 of the invention will now be described. Referring to FIG. 3, the lamp 70 is installed into the lamp/switch mount 32 along with the contacts 72a,b. The electrical switch 34 is connected to the lamp/switch mount 32. The push-button 24 is connected to the actuator 52. The spring 60 is inserted into the top end 36 of the body 26 and the actuator 52 is guided over the top end of the spring. The actuator 52 is pressed downwardly, compressing the spring 60 until the catches 56 of the legs 54a,54c of the actuator 52 engage the bottom end 38 of the body 26.

The lamp/switch mount 32 is then connected to the body 26. As described above, the lamp/switch mount 32 is aligned with the legs 54a,b,c and latches 88,90 and pressed upwardly. The legs 54a,b,c extend through the recesses 64a,b,c in the lamp/switch mount 32. The latch 90 extends through the passage 92, and the latch 88 extends along the cut-out 94. Upon further upward movement, the catches on the latches 88,90 extend over the bottom surface of the main portion 62 of the lamp/switch mount 32, locking it to the body 26.

The recessed switch 20 may be conveniently mounted to the housing 22. First, the protector 10 is extended over the bottom end 38 of the body 26 and moved upwardly as far as possible. Next, the bottom end 38 of the body 26 is passed through an aperture in the housing 22 until the lip 14 of the protector 10 rests upon or abuts the housing 22. The locking nut 30 is then engaged with the threads on the outer surface of the body 26 from the bottom end 38. The locking nut 30 is threaded upwardly until it engages the housing 22.

Appropriate wiring (not shown) is attached to the contacts 72a,72b for providing power to the lamp 70. Appropriate wiring (not shown) is also attached to the leads 86a,b,c of the electrical switch 34.

In use, a user depresses the push-button 24. The push-button 24 moves the actuator 52 downwardly against the force of the spring 60. Sufficient downward movement causes the foot 58 of the leg 54b to engage the switch button 84, actuating the electrical switch 34. Upon release of the user-applied pressure or force, the spring 60 moves the actuator 52 and push-button 24 upwardly.

Electro-static discharge (ESD) from the player may be routed away from the circuitry of the recessed switch 20. In accordance with the invention, when a player touches (or comes sufficient close to the recessed switch 20 that a discharge may arc through the air space and bridge to the switch) the recessed switch 20, the discharged electrical energy is routed to the housing 22 or a remote location, grounding the discharge. In the preferred embodiment, the discharged is routed through the conductive material in the body 26, protector 10 and/or lock nut 30 to the housing 22. This path routes the electrical energy away from the lamp circuit or the switch circuit.

In accordance with the invention, a recessed switch 20 is provided which is simple to assemble and disassemble. In particular, replacement of the lamp 70 is facilitated. In the event the lamp 70 burns out and needs replacing, the lamp/switch mount 32 is easily disengaged from the body 26, providing access to the lamp 70 for replacement. In order to disengage the lamp/switch mount 32, a user need only bias the catches of the latches 88,90 out of engagement with the lamp/switch mount 32. Then, the user may move the lamp/switch mount 32 downwardly with respect to the body 26 for access to the lamp 70.

As another aspect of the invention, the recessed switch 20 has an illuminated body 26, and illuminated protector 10, or both surrounding the user-actuatable push-button 24. The illuminated body 26 aids in defining to a user the location of the push-button 24.

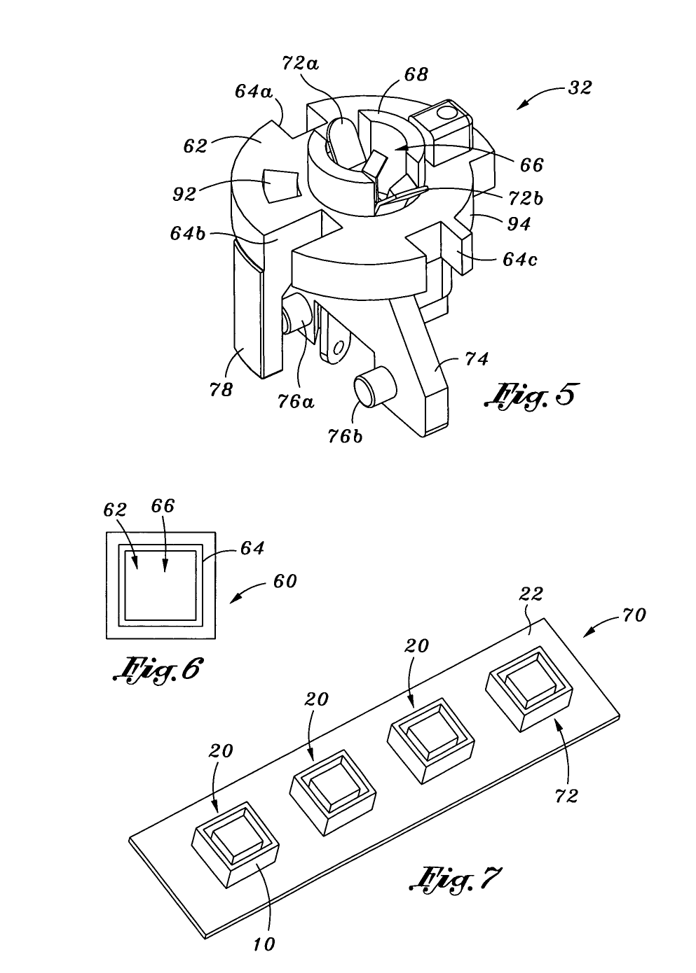

A method of retrofitting a push-button actuatable switch in accordance with the invention will now be discussed with reference to FIG. 6. The push-button switch to be retrofitted is first disconnected from its support structure, such as the housing 22 of a gaming machine. The push-button switch may be disconnected by completely removing it from the gaming machine or by simply loosening it from the gaming machine. In one or more embodiments the push-button switch to be retrofitted comprises a body having two ends, the two ends located at either side of a support structure, whereby the body must be removed from that support structure. Thus, for example, the push-button switch may be completely removed for particular types of protectors, such as protectors which are mounted by inserting one end of the push-button switch into an opening of the protector. In the case of protectors comprised of two halves (or multiple separate portions), the push-button switch may simply be loosened to allow each half or portion to be slid in place. In this way a multi-part protector can be used to retrofit a push-button switch without having to completely remove the switch.

Once the push-button actuatable switch has been disconnected, a protector 60 such as illustrated in FIG. 6 (from above) may be mounted to the body of the push-button switch. As illustrated, the protector 60 has an open top 62, a base portion 64, and a passage there through 66 to accept the body of a push-button switch. The protector 60 may extend upwardly around a portion or the entire perimeter of the push-button switch. In some embodiments, the protector 60 may have a arbitrary shape unrelated to the shape of the perimeter of the push-button switch. In addition, the protector 60 may extend even with or beyond the user-actuatable portion of the push-button switch when the push-button switch is in its non-actuated position.

It is contemplated that a protector 60 for retrofit purposes may have any or all of the elements of the protectors described above as desired. As discussed above, the protector 60 may have a threaded portion corresponding to a corresponding threaded portion on the body of the push-button switch. In this embodiment, the protector 60 may be mounted to the body by threading its threaded portion on to the corresponding threaded portion of the body. The protector 60 may then be permanently secured such as through fasteners, adhesive, or both. Also as discussed above, the protector 60 may be comprised of two halves with each half configured to accept a portion of the body and connect together to form the protector. In this embodiment, the protector 60 may also then be permanently secured such as through fasteners, adhesive, or both. Of course, the protector 60 of various embodiments may have more than two halves (i.e. more than two portions) as desired. In addition, the protector 60 may have a lip to accept the body of the push-button switch in one or more embodiments, including embodiments where the protector is comprised of two or more portions.

As illustrated in FIG. 4B, a push-button actuatable switch may have a flange 68 as part of its body. Where this is the case, the protector 60 may be located beneath the flange 68 and above a supporting structure. For example, the protector 60 may be mounted between the flange and the housing 22 of a gaming machine such as shown in FIG. 2. It is noted that, the protector 60 may be mounted to the body in various ways such as but not limited to clips, screws, pins, other fasteners, or adhesives.

After the protector 60 has been mounted to the push-button actuatable switch, such as the body thereof, the push-button switch is reconnected to a supporting surface, such as the housing 22 of a gaming machine. It is contemplated that the push-button switch and protector 60 may be reconnected to a housing 22 different than the housing that the push-button switch was removed from. In addition, it is contemplated that the method herein may be used to retrofit a push-button switch before it has ever been connected to a housing 22.

FIG. 7 shows the housing 22 of a gaming machine 70 having several recessed push-button actuatable switches 20 mounted thereto. This is a typical configuration of push-buttons on a gaming machine where the buttons are mounted in a row in close proximity. The close proximity of the buttons is a partial cause of accidental or inadvertent engagement of the buttons. For example, a user playing a game of Blackjack may accidentally press the “deal” button while intending to press the “hold” button located directly adjacent to the “deal” button. This is especially so in casino environments where patrons are excited by playing the game and where alcohol is readily obtained and consumed.

As indicated above, the protector of the invention may be utilized with push-button switches having a variety of configurations. For example, the switch may have a generally square push-button, as illustrated in the figures herein. However, the push-button may be round, rectangular or have other shapes. In such instances, the shape of the protector may vary.

In one embodiment, it is possible for the protector to be usable with multiple push-button switches. For example, the protector may be elongate and define a single opening within which multiple push-buttons may be located. Alternatively, the protector may have multiple openings and push-buttons may be located in each opening. In this configuration, only a single protector might need to be installed in order to retrofit multiple push-buttons.

Also, the configuration of the switch itself may vary. The switch (or the push-button thereof), need not be illuminated. In addition, the internal components and arrangement of the switch may vary substantially from the particular embodiment detailed above.

The invention has numerous advantages. The location of the protector around the push-button substantially reduces the probability of the push-button from being accidentally pressed, while allowing the same to be purposefully engaged or actuated. In particular, unless direct contact is made with the top of the push-button, the push-button is not depressed. For example, if a user's arm comes into contact with the switch, their arm is likely to contact the protector, which prevents downward movement of the user's arm in a manner which would actuate the push-button.

The problem of accidental button engagement affects the gaming establishment as well as its patrons. A common problem for gaming establishments is accidental activation of the service button 72 on a gaming machine. As shown in FIG. 7, the service button 72 is typically identical in appearance to the game buttons on a gaming machine except for its text label. When pressed, a service technician must respond to the service call such as by repairing the machine or verifying a jackpot or payout.

Activating the service button starts a chain of events in response to the needs of a patron for some kind of gaming machine service. The call for service is first detected and the machine with the pressed service button is then identified. Next, an available technician is located and once located is dispatched to the identified machine. The technician must then make his or her way to the machine, which can be a long distance away in today's larger gaming establishments. All of this activity is unnecessary and costly when the service button is accidentally pressed. In addition, in many establishments, this process is not automated and requires a measurable amount of human effort every time a service button is pressed.

Despite the amount of energy and time wasted by accidental activation or engagement of the service button, gaming establishments must keep these service buttons easily accessible to its patrons in case of a genuine need for service. Thus, placing the service button where it will not be accidentally pressed is not a viable option. Therefore, one advantage of the invention is that the service button does not have to be moved and may remain easily accessible to patrons who require service. At the same time, the invention protects the service button from being accidentally pressed even, as is typical in many gaming machines, when the service button is located near game buttons.

Another advantage of the invention is that it may be used to retrofit existing push-buttons (such as used with existing gaming machines). Thus, for example, one or more gaming machines could have their service or other buttons retrofitted with minimal effort and expense. Alternatively, these gaming machines could have all their buttons retrofitted so that both patrons and the gaming establishment are protected from accidental button presses as described above. It is noted that the protector of the invention could be formed integrally with the body or other portion of a push-button. However, the configuration of the protector of the invention as a separate element has particular advantages. In particular, this configuration permits the protector to be used to retro-fit existing gaming machine buttons. The cost of replacing an entire button may be an order of magnitude of as much as 10 times the cost of simply retro-fitting an existing push-button switch with a separate protector. Thus, the configuration of the invention makes it much more cost effective to retro-fit existing buttons. In addition, the separate protector is less time intensive to install than replacing the entire button, and the separate protector can be used with push-button switches having various embodiments, which is much more economical than having to create numerous molds to reconfigure numerous existing types of buttons with integral protectors.

Other advantages of the invention are that it is effective, durable, simple to maintain, and inexpensive. Traditional methods of preventing a button from being accidentally pressed include recessing the entire button into a housing, or use of covers or flaps which may be moved over the top of the button. The present invention has advantages over these other potential solutions. In gaming, recessing the button often creates a gap between the button and the protective housing of the gaming machine. This is a security issue as it may provide an access point into the gaming machine that would allow the machine to be tampered with. In addition, such a configuration would require the entire housing of the gaming machine to be modified to include recesses for the buttons. Such fabrication would be very expensive, and retrofitting would be nearly impossible.

A removable flap or cover is inconvenient in a gaming environment because such covers are prone to breaking in a high use environment where the cover may be repeatedly bumped or opened and closed. Replacement of the cover or flap itself would then be a source of additional service calls to technicians. In addition, relative to frequently used buttons, such covers or flaps would greatly increase the time necessary to play games or engage in other functions, owing to the time needed to access the buttons.

Therefore, yet another advantage of the invention is that it is a simple solution that will reduce the number of accidental and actual service calls that a gaming machine produces. The invention is easy to install, requires little or no maintenance, and has no moving parts, covers or flaps which may be broken. Furthermore, the invention does not obscure the service button or any other button while being highly effective at preventing accidental presses.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A push-button actuatable switch comprising:
a button body having a first end and a second end;
a push-button supported by said body and extending from said first end of said body, said push-button having a user actuatable portion;
a switch, said push-button movable from a first non-actuated position to a second actuated position in which said push-button actuates said switch; and
a protector mounted to said body and extending upwardly around at least a portion of said push-button, said protector having an open top end extending even with or beyond said user-actuatable portion of said push-button when said push-button is in said non-actuated position.

2. The push-button actuatable switch of claim 1 wherein said protector further comprises a first half and a second half, each half configured to accept a portion of said body.

3. The push-button actuatable switch of claim 2 wherein said first half further comprises one or more fasteners and said second half further comprises one or more corresponding fasteners, said protector being assembled by connecting said one or more fasteners to said one or more corresponding fasteners.

4. The push-button actuatable switch of claim 1 wherein said protector further comprises a threaded portion and wherein said body further comprises a corresponding threaded portion, said protector being mounted to said body by threading said threaded portion onto said corresponding threaded portion.

5. The push-button actuatable switch of claim 1 wherein said protector further comprises a bottom end opposite said top end, said bottom end comprising a lip to accept said body of said push-button.

6. The push-button actuatable switch of claim 1 wherein said protector extends around the entire perimeter of said push-button.

7. A gaming machine having a push-button actuatable switch comprising:
a gaming machine having a housing defining a generally closed interior area and an exterior area; and
a push-button actuatable switch mounted to said housing of said gaming machine, said push-button actuatable switch comprising:
a button body having a first end and a second end, said body extending through said housing of said gaming machine from said interior area to said exterior area thereof;
a push-button supported by said body and having a user-actuatable portion extending from said first end of said body so as to be accessible at said exterior area of said gaming machine;
a switch, said push-button movable from a first non-actuated position to a second actuated position in which said push-button actuates said switch; and
a protector mounted to said button body and extending upwardly around at least a portion of said push-button, said protector having an open top end extending even with or beyond said user-actuatable portion of said push-button when said push-button is in said non-actuated position.

8. The gaming machine having a push-button actuatable switch of claim 7 wherein said protector is mounted between a flange defined by said body and said housing of the gaming machine.

9. The gaming machine having a push-button actuatable switch of claim 7 wherein said protector extends upwardly around the entire perimeter of said push-button.

10. The gaming machine having a push-button actuatable switch of claim 7 wherein said gaming machine has a plurality of said push-button actuatable switches mounted to said housing of said gaming machine.

11. The gaming machine having a push-button actuatable switch of claim 7 wherein said protector has a peripheral shape corresponding to the peripheral shape of said push-button;

12. A method of retrofitting a push-button actuatable switch of a gaming machine to reduce accidental user actuation thereof comprising:
disconnecting a push-button actuatable switch comprising a button body having a first end and a second end, a push-button supported by said body and having a user-actuatable portion extending from said first end of said body, and a switch, said push-button movable from a first non-actuated position to a second actuated position in which said push-button actuates said switch, from a housing of said gaming machine;
mounting a protector to said button body whereby said protector extends upwardly around at least a portion of said push-button, said protector having an open top end extending even with or beyond said user-actuatable portion of said push-button when said push-button is in said non-actuated position; and
reconnecting said push-button actuatable switch to said gaming machine.

13. The method of retrofitting a push-button actuatable switch of claim 12 wherein said protector further comprises a body having a base portion and an upwardly extending wall, said protector defining a passage there through for accepting the button body of said push-button actuatable switch.

14. The method of retrofitting a push-button actuatable switch of claim 13 wherein said upwardly extending wall of said protector extends around the entire perimeter of said push-button.

15. The method of retrofitting a push-button actuatable switch of claim 12 wherein said protector further comprises a first half and a second half, each half configured to accept a portion of said body.

16. The method of retrofitting a push-button actuatable switch of claim 15 wherein said step of mounting said protector further comprises:
placing said first half around a portion of said body;
placing said second half around a remaining portion of said body; and
attaching said first half and said second half to form an assembled protector, wherein said first half and said second half are attached by one or more fasteners, adhesive, or both.

17. The method of retrofitting a push-button actuatable switch of claim 12 wherein said protector is located beneath a flange defined by said body and where when mounted said protector is between said flange and a portion of said gaming machine.

18. The method of retrofitting a push-button actuatable switch of claim 12 wherein said protector further comprises a threaded portion and wherein said body further comprises a corresponding threaded portion.

19. The method of retrofitting a push-button actuatable switch of claim 18 wherein said step of mounting said protector further comprises:
threading said threaded portion of said protector onto said corresponding threaded portion of said body; and
optionally securing said protector to said body with one or more fasteners, adhesive, or both.

20. The method of retrofitting a push-button actuatable switch of claim 12 wherein said step of mounting a protector to said body is performed prior to the first mounting of said push-button actuatable switch to a gaming machine.
